(19) United States
(12) Patent Application Publication
(10) Pub. No.: US 2002/0019164 A1
(43) Pub. Date: Feb. 14, 2002

(54) Electrical connector, especially for use in the sensor field

(75) Inventors: Helmut Fuchs, Halver (DE); Wolfgang Conrad, Schalksmuhle (DE)

Correspondence Address: THE FIRM OF KARL F ROSS, 5676 RIVERDALE AVENUE, PO BOX 900, RIVERDALE (BRONX), NY, 10471-0900, US

(73) Assignee: Karl Lumberg GmbH & Co.

(21) Appl. No.: 09/904,443

(22) Filed: Jul. 12, 2001

(30) Foreign Application Priority Data
Jul. 15, 2000 (DE) 10034501.8

(51) Int. Cl. H01R 4/24

(52) U.S. Cl. 439/404

(57) ABSTRACT

A base body with a grip portion at an angle to a contact carrier can be molded in one piece and contacts in the contact passages can be provided in an inactive position until the leads of a conductor are inserted into channels intersecting the contact passages. Then the contacts are pressed into their active positions in which pointed ends of the contacts pierce the insulation of the leads and make electrical contact with the core thereof. The potting mass is filled into the space around the conductor within the sleeve segment of the gripping portion and can extend onto the conductor to form a buckling preventer. The connection is particularly suitable for connection to sensors and the like.

### SPECIFICATION

### FIELD OF THE INVENTION

Our present invention relates to an electrical connector, especially for use in the sensor field and of the type in which an insulating body has contacts which are connected to leads of a conductor and the contact carrier is provided with a grip enabling the connector to be inserted in a jack and removed from a jack.

### BACKGROUND OF THE INVENTION

Electrical connectors which have contact carriers whose contacts can engage leads of an adapter or cable can be made by injection molding the contact carrier from an electrically-insulating material and forming the contact carrier with slender throughgoing bores corresponding in number to the number of poles of the connector or plug. The diameter of the bores is determined by the size of the crimp contacts to be removed therein, each contact being crimped to an end of a lead of a cable from which the jacket must be removed. The ends of the leads must have their insulation also removed.

Usually the individual crimp contacts are pressed one after the other by an auxiliary device in the respective receiving bores of the contact carrier and then a retaining nut is usually applied and the assembly placed in a mold in which a grip body is molded onto the contact carrier of a thermoplastic synthetic resin, like polyurethane, by an injection-molding technique. The grip body, formed as a separate piece, closes the rear end of the jacket carrier and can engage the jacket of the electrical conductor or cable.

The connectors of this type have been found to be highly useful, especially in the sensor field and particularly for connection to proximity switches and like sensors and control devices. Reference may be had to DE 197 25 732 A1 with respect to the cable guide channels and terminals which penetrate insulation, to DE 82 28 161 U1 particularly with reference to snap-on retaining nuts, and to DE 43 41 958 A1 which deals with connectors using potting resins.

### OBJECTS OF THE INVENTION

It is therefore an object of the present invention to provide an improved angular connector of the aforedescribed type but which can be fabricated in a simpler manner and which also can be used in a simple but effective way.

Another object of this invention is to provide a connector for a plug and jack system which is especially effective for use in the sensor field, e.g. for connection to proximity switches and the like, whereby drawbacks of earlier connectors are avoided.

Yet another object is to provide an improved method of making a plug-type connector whereby manufacturing drawbacks with earlier connectors are avoided.

### SUMMARY OF THE INVENTION

These objects and others which will become apparent hereinafter are attained, in accordance with the invention, in an electrical plug connector, especially for use in conjunction with sensors and control devices like proximity switches, which comprises:

a connector body formed with an elongated contact carrier prefabricated from an electrically insulating material and formed with a plurality of contact passages opening at an end of the contact carrier, and a grip portion formed in one piece with the contact carrier at an opposite end thereof and formed with channels for respective insulated conductive leads insertable through the channels into the grip portions, each of the channels intersecting the passages at an angle other than zero degrees; and

respective contacts received in the contact passages and having rear ends turned away from the opening and formed with respective penetration points engaging through insulation of the leads to make electrical contact with the leads in effective positions of the contacts upon pressing of the contacts from ineffective positions, wherein the respective points are out of paths of the respective insulated conductive leads, into the effective positions.

According to the invention, the grip body or portion is formed in one piece with the contact carrier and, therefore, the body of the connector is a one-piece insulating body which consists of the grip portion and the contact carrier which form components of the insulating body and can be produced by injection molding along with the contact passages. The grip portion is injection molded together with the contact carrier but at an angle thereto. The contact portion is formed during the injection molding process with the contact passages and the grip portion is formed simultaneously with the channels receiving the leads which intercept these passages. Within the contact passages, respective contacts are mounted which initially are in an ineffective position, with their tips or points retracted from the respective channels so that the insulated leads of the conductor can be inserted freely into the respective channels. Only then are the contacts pressed inwardly, i.e. away from the opening of the contact carrier so that the points or tips cut into the insulation of the respective leads and engage the conductors thereof. The contacts are thus displaced from their ineffective positions into their effective positions.

The system of the invention has a number of significant advantages both with respect to fabrication of the connector and the use thereof. The application of the conductor to the connector is greatly simplified since it is no longer necessary to crimp the connection between the contacts and the leads. The electrical connection is made simply by driving the contacts with their pointed portions through the insulation of the leads by pressing the contacts from their ineffective positions into their effective positions. The points thereby cut through the insulation to engage the electric wires at the core of the respective leads.

The one-piece configuration of the grip and the contact carrier eliminates the need for separately forming the grip and it is only necessary, preliminarily, to shifting the contacts, to anchor the conductor and its leads in the grip portion of the connector body.

The angle at which the grip portion meets the contact support can be so selected that the penetration tips of all or as many of the contacts as possible, lie in the same plane in the effective positions, i.e. the actual electrical connections of the contacts with the leads are coplanar. This ensures uniform geometry and the same electrical flow paths between the contact members themselves and the conductor and guarantees that all of the contacts will be brought into their effective positions by the same degree of shift within the plug connector.

The grip body can have a sleeve section into which a closure member can be inserted for locking the conductor or leads in place and this member can be a potting mass, e.g. a thermoplastic material which forms an intimate bond to the material of the connector body and preferably cross-links therewith.

The individual leads can be inserted into their respective channels without application of force and the conductor can then be anchored in place by introducing the thermoplastic filling mass into the sleeve portion. The mass, upon setting, will hold the conductor in place and can, to the extent that it extends beyond the connector and around the conductor, provide a buckling preventer for the conductor.

The grip body can also be formed with a large-section funnel which converges from the sleeve segment toward the channels and has surfaces guiding the leads into the channels. As a result, the insertion of the leads into the channels is greatly facilitated. The funnel surfaces function as guides for this purpose.

The invention can also be considered to be a method of making the electrical plug connector which comprises the steps of:

molding a connector body from an electrical insulating material with an elongated contact carrier formed with a plurality of contact passages opening at an end of the contact carrier and a grip portion at an opposite end of the contact carrier formed with a sleeve section, a funnel-shaped section extending inwardly from the sleeve section, and a plurality of channels for respective insulated conductive leads of a conductor, each of the channels intersecting a respective one of the passages at an angle other than 0°;

disposing at ineffective positions in the contact passages, the contacts having rear ends turned away from the opening and formed with respective penetration points out of the path of the leads insertable into the channels;

introducing a conductor into the body having insulated conductive leads separated from one another, whereby the leads pass freely into the channels and a body of the conductor is disposed in the sleeve segment;

potting a thermoplastic mass in the sleeve segment and around the body of the conductor to anchor the conductor in the connector body and the leads in the channels and to form a buckling preventer along the conductor adjacent the plug connector; and

pressing the contacts away from the opening in the contact passages until the points penetrate insulation of the leads and make electrical contact with conductors thereof.

Preferably the angle between the grip portion and the contact support is about 120°.

### BRIEF DESCRIPTION OF THE DRAWING

The above and other objects, features, and advantages will become more readily apparent from the following description, reference being made to the accompanying drawing in which:

FIG. 1 is a cross sectional view of the connector of the invention in the course of insertion of the leads; and

FIG. 2 is a similar view of the finished connector.

### SPECIFIC DESCRIPTION

A plug connector 10 according to the invention comprises a contact carrier 11 onto which a retaining nut 12 has been snapped past a shoulder 30. The contact carrier 11 is injection molded in one piece with a grip portion 13 and both the contact carrier 11 and the grip portion 13 are composed of a rigid electrically insulating material. The body formed by members 11 and 13 has been represented as a whole at 18 and will be referred to hereinafter as the base body. It is formed in one piece with the shoulder 50 at the end of the contact support 11 remote from the openings 51 thereof.

The contact carrier 11 has a multiplicity of mutually parallel contact passages 17. Each of the passages 17 receives a respective contact 16 which in the illustrated embodiment is a fork contact. While a fork contact configuration is preferred, it can, of course, also be a tubular contact.

At the rear or inner end of the contact 16, the latter is provided with a pointed and sharpened portion, which can also be described as a blade, and will be mentioned subsequently.

The grip portion 13 has, at its inlet side, a sleeve segment which can have a relatively thin wall and whose outer diameter exceeds the outer diameter of the jacket of a cable 15 to be received therein. Functionally the grip portion had to be injection molded around the cable.

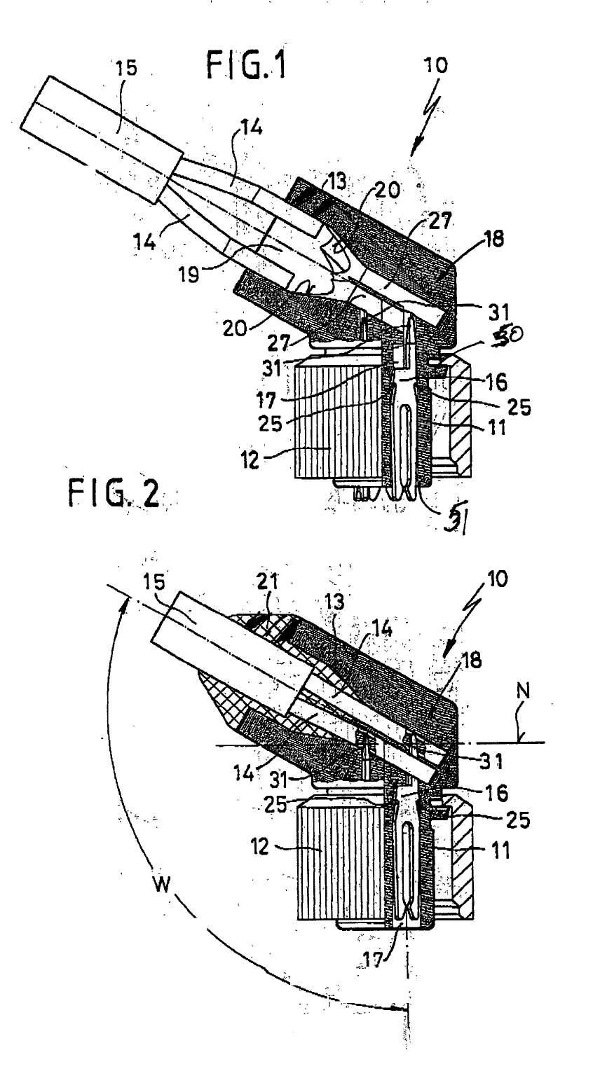

With the present invention, the conductor 15 can be inserted (compare FIGS. 1 and 2) into the relatively large volume hollow 19 which leads to a large-cross section funnel 20 whose flanks converge and guide the leads 14 with their insulating sheaths intact, into the channels 27 of the grip portion 13. The channels 27 intersect the passages 17 at an angle, preferably of about 120°. The number of channels 27 is thus equal to the number of passages 16 and the number of poles of the connector.

Since the contacts do not, at this stage, project into the channels 27, the leads 14 can be introduced without the need to apply force. In the case of the four-pole connector as has been shown in the drawing, all four leads 14 can be inserted simultaneously and, once the conductor 15 is received in the sleeve segment, a thermoplastic potting mass can be introduced and can set to cross-link with the material of the base body 18. For example, the potting mass can be composed of polyvinyl-chloride or polyurethane or can simply be a hot-melt adhesive or the like. The potting mass 21 can extend over the jacket of the cable or conductor to form a kink or buckling preventer therewith. The system of the invention does not require an injection molding machine for complying the body mass in its thermoplastic state to the engagement of the contact 16 with the conductors of the leads 14. This can be effected by pressing the contacts 16 upwardly from their ineffective positions shown in FIG. 1 into their effective positions shown in FIG. 2 so that the penetrating points or blades 31 will pierce and cut through the insulation of the lead and contact the conductive core.

The electrical connections are all made in the plane N and each of the contacts 16 can be held in place by projections 25 which form barbs engaging the wall of the respective passage 17. The displacement of the contact can be effected prior to or subsequent to the application of the potting mass 21. In the former case, the contacts hold the leads in place during potting and in the latter case, the potting mass holds the leads in place for the engagement of the contacts therewith. The angle W is so selected that the contacts re made in the common plane N and thus so that the conductive paths of all of the contacts are equal (FIG. 2).

The illustrated embodiment can represent a four-fold connector as has been noted, or a five-pole connector. Two poles are clearly visible. The two further conductors are behind those shown. Similarly, as many poles as desired can be provided in the contact carrier 11 with appropriate dimensioning.

We claim:

1. An electrical plug connector, especially for use in conjunction with sensors, comprising:
a connector body formed with an elongated contact carrier prefabricated from an electrically insulating material and formed with a plurality of contact passages opening at an end of said contact carrier, and a grip portion formed in one piece with said contact carrier at an opposite end thereof and formed with channels for respective insulated conductive leads insertable through said channels into said grip portions, each of said channels intersecting said passages at an angle other than zero degrees; and
respective contacts received in said contact passages and having rear ends turned away from said opening and formed with respective penetration points engaging through insulation of said leads to make electrical contact with said leads in effective positions of said contacts upon pressing of said contacts from ineffective positions wherein the respective points are out of paths of the respective insulated conductive leads into said effective positions.

2. The electrical plug connector defined in claim 1 wherein said channels intersect said passages at the same angle and said angle is selected such that all of said points engage said leads in substantially a common plane.

3. The electrical plug connector defined in claim 2 wherein said grip portion has a sleeve segment, said connector further comprising a closure member received in said sleeve portion and anchoring said insulated conductive leads in said connector.

4. The electrical plug connector defined in claim 3 wherein said leads extend from a conductor body extending into said sleeve portion and anchored by said member therein.

5. The electrical plug connector defined in claim 3 wherein said member is a thermoplastic mass filling said sleeve portion and intimately bonded to said body.

6. The electrical plug connector defined in claim 5 wherein said mass is cross-linked with material of said body.

7. The electrical plug connector defined in claim 5 wherein said leads are inserted substantially force-free into said channels and are then secured therein by potting of said leads in said body by said thermoplastic mass.

8. The electrical plug connector defined in claim 5 wherein said mass extends from said sleeve portion around a conductor provided with said leads to form a buckling preventer therefor.

9. The electrical plug connector defined in claim 8 wherein said grip portion is formed with a large-cross-section funnel having surfaces converging toward said channels for guiding said leads into said channels.

10. The electrical plug connector defined in claim 8 wherein said contact carrier has a retaining nut snapped onto it remote from the plug-in side thereof.

11. The electrical plug connector defined in claim 1 wherein said grip portion has a sleeve segment, said connector further comprising a closure member received in said sleeve portion and anchoring said insulated conductive leads in said connector.

12. The electrical plug connector defined in claim 11 wherein said leads extend from a conductor body extending into said sleeve portion and anchored by said member therein.

13. The electrical plug connector defined in claim 12 wherein said member is a thermoplastic mass filling said sleeve portion and intimately bonded to said body.

14. The electrical plug connector defined in claim 13 wherein said mass is cross-linked with material of said body.

15. The electrical plug connector defined in claim 13 wherein said leads are inserted substantially force-free into said channels and are then secured therein by potting of said leads in said body by said thermoplastic mass.

16. The electrical plug connector defined in claim 13 wherein said mass extends from said sleeve portion around a conductor provided with said leads to form a buckling preventer therefor.

17. The electrical plug connector defined in claim 1 wherein said grip portion is formed with a large-cross-section funnel having surfaces converging toward said channels for guiding said leads into said channels.

18. The electrical plug connector defined in claim 1 wherein said contact carrier has a retaining nut snapped onto it remote from the plug-in side thereof.

19. A method of making a plug connector for use in conjunction with sensors comprising the steps of:
molding a connector body from an electrical insulating material with an elongated contact carrier formed with a plurality of contact passages opening at an end of said contact carrier and a grip portion at an opposite end of said contact carrier formed with a sleeve section, a funnel-shaped section extending inwardly from said sleeve section, and a plurality of channels for respective insulated conductive leads of a conductor, each of said channels intersecting a respective one of said passages at an angle other than 0°;
disposing at ineffective positions in said contact passages, said contacts having rear ends turned away from said opening and formed with respective penetration points out of the path of the leads insertable into said channels;
introducing a conductor into said body having insulated conductive leads separated from one another, whereby said leads pass freely into said channels and a body of said conductor is disposed in said sleeve segment;
potting a thermoplastic mass in said sleeve segment and around said body of said conductor to anchor said conductor in said connector body and said leads in said channels and to form a buckling preventer along said conductor adjacent said plug connector; and
pressing said contacts away from said opening in said contact passages until said points penetrate insulation of said leads and make electrical contact with conductors thereof.

20. The method defined in claim 19 wherein said angle is about 120°.
